(19) United States
(12) Patent Application Publication
(10) Pub. No.: US 2010/0183171 A1
(43) Pub. Date: Jul. 22, 2010

(54) Structure of Speaker

(75) Inventors: Yueh-Hua HSU HUANG, Taipei Hsien (TW); Ching-Hui HUANG, Taipei Hsien (TW)

Correspondence Address: SCHMEISER OLSEN & WATTS, 18 E UNIVERSITY DRIVE, SUITE # 101, MESA, AZ, 85201, US

(73) Assignee: JAZZ HIPSTER CORPORATION, Taipei Hsien (TW)

(21) Appl. No.: 12/356,929

(22) Filed: Jan. 21, 2009

(51) Int. Cl. H04R 1/00

(52) U.S. Cl. 381/150

(57) ABSTRACT

An improved structure of a speaker comprises a cone frame, a surround and a diaphragm, wherein a circumference of the diaphragm is sealed to an edge of an opening of the cone frame. A container portion is disposed on an inner side of the opening of the cone frame. The surround is disposed between the diaphragm and the container portion of the cone frame. Therefore, when an audio-frequency electrical signal is coupled with a voice coil inside the cone frame, the voice coil outputs an audio signal to drive the diaphragm to move and generate a sound. The present invention uses the surround to let the diaphragm move up and down with less resistance, which helps the diaphragm move more smoothly and reduces a distortion of sounds and increases the sensitivity of sound pressure level by enlarging the diaphragm moving area.

### BACKGROUND OF THE INVENTION

1. Field of the Invention

The present invention relates to an improved structure of a speaker, and more particularly, to a speaker structure which can effectively reduce a sound distortion by smoother excursion.

2. Description of the Prior Art

The operation principle of a speaker is based on the Fleming's left hand rule, wherein an electrified voice coil is placed in a magnetic field and driven by the reactive force to generate movement, thereby driving a vibrating plate to yield sound energy by causing the air to move. Therefore, the speaker is an audio device which can convert an electrical signal into mechanical energy to let the air move. To be precise, the operation of the speaker is to convert an audio-frequency electrical signal with a certain frequency range into a low-distortion and audible sound with enough sound pressure level.

The moving coil type of speakers is commonly used presently. A moving coil speaker comprises a magnetic circuit module including permanent magnetic, core pole piece and magnetic top plate; a moving module including cone membrane, suspension surround, voice coil; and a supporting module including spider, cone frame, gasket pad, wherein the voice coil is fixed to the diaphragm. When an audio-frequency electrical signal is coupled with the voice coil, the wire-wound cylindrical voice coil in the permanent magnetic field is connected with the diaphragm. Driven by the electrical signal, the voice coil and the diaphragm connected to the voice coil move together and then generate sounds.

The major difference between the moving coil speaker and other speakers is in the diaphragm. The edge of diaphragm is usually fixed to an elastic medium including surround and spider. For example, in a large-size woofer unit, the diaphragm is usually in cone shape and is vibrated with the elastic medium. From FIG. 1A and FIG. 1B, in a moving coil speaker, an edge of a diaphragm 1 is directly fixed to a frame of a driving unit. The diaphragm 1 comprises a lateral surround 2. A moving module of the speaker is moved by the stretching and retracting movement of the diaphragm 1 and the deformation of the surround 2. Therefore, the choice of the material and the designed shape of the diaphragm 1 in the moving coil speaker are critical to the sound quality of the speaker. When the surround 2 of the diaphragm 1 moves up and down, some of the movements are twisted by the folds on the surround 2 and thus causes a sound distortion.

Therefore, the traditional structure of speakers presents some shortcomings to be overcome.

In view of the above-described deficiencies of the traditional structure of speakers, after years of constant efforts in research, the inventor of this invention has consequently developed and proposed an improved structure of a speaker.

### SUMMARY OF THE INVENTION

It is an object of the present invention to provide an improved structure of a speaker which helps a diaphragm of the speaker move more smoothly with less resistance and reduces a distortion of sounds when a voice coil of the speaker moves.

The improved structure of the speaker comprises a cone frame and a moving module, wherein the moving module is connected with the cone frame, and the moving module comprises a surround and a diaphragm. A circumference of the diaphragm is sealed to an edge of an opening of the cone frame. A container portion is disposed on an inner side of the opening of the cone frame, and the surround is vertically connected with the diaphragm and the container portion of the cone frame. Therefore, when an audio-frequency electrical signal is coupled with a voice coil inside the cone frame, the voice coil moves to drive the diaphragm to move and generate a sound. The present invention uses the surround to reduce the resistance of the diaphragm excursion, which helps the diaphragm move more smoothly and reduces a distortion of the sound while compared with the conventional structure.

### BRIEF DESCRIPTION OF THE DRAWINGS

FIG. 1A illustrates a partially perspective view of a conventional speaker;

FIG. 1B illustrates a 3D view of the conventional speaker;

FIG. 1C illustrates a sectional view of the conventional speaker;

FIG. 2A illustrates a partially perspective view of an improved structure of a speaker;

FIG. 2B illustrates a 3D view of the improved structure of the speaker;

FIG. 2C illustrates a sectional view of the improved structure of the speaker; and

FIG. 3 illustrates a sectional view of an embodiment of the improved structure of the speaker in the present invention.

### DETAILED DESCRIPTION OF THE PREFERRED EMBODIMENT

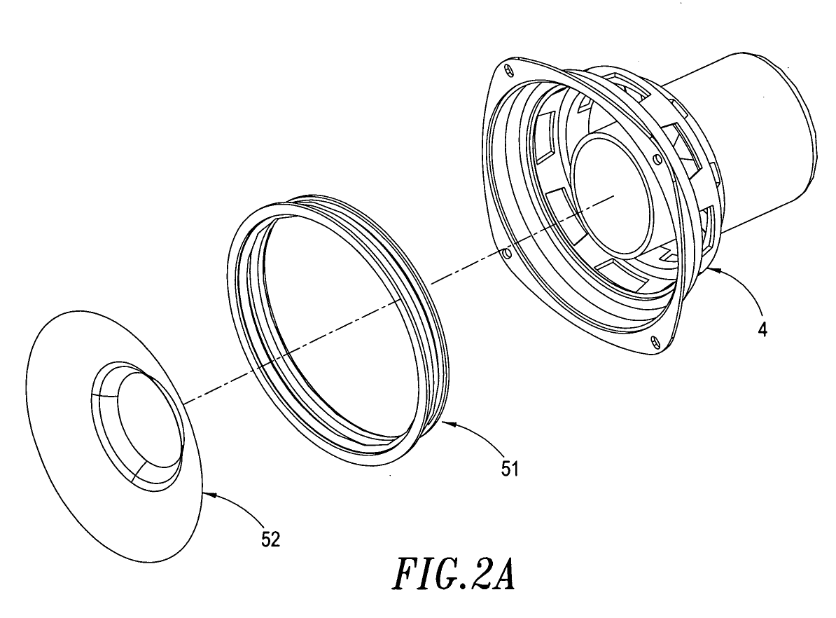

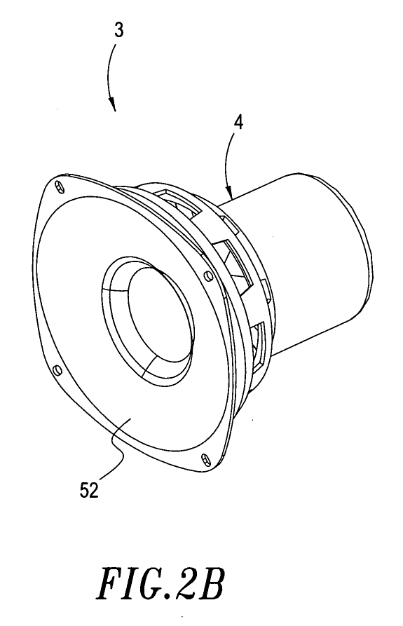

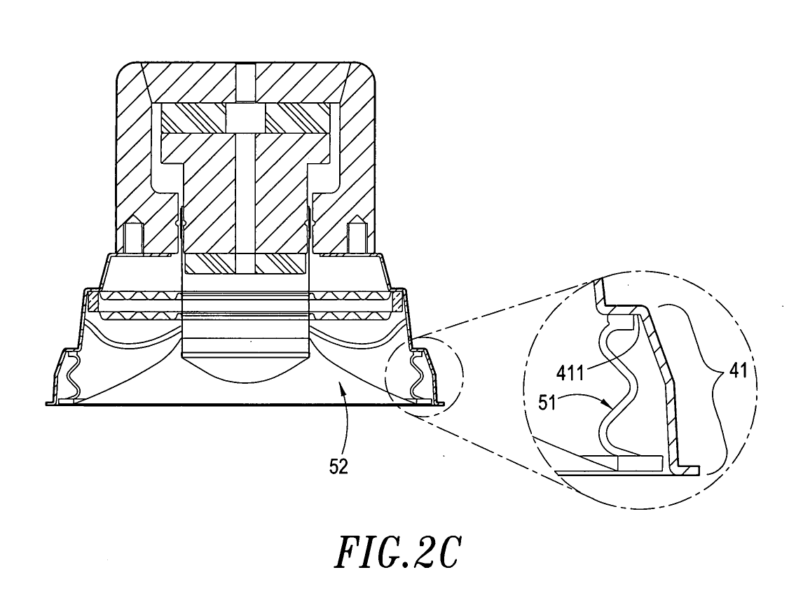

Please refer to FIG. 2A, FIG. 2B and FIG. 2C for the partially perspective view, 3D view and sectional view of an improved structure of a speaker. From the figures, the speaker unit 3 at least comprises a cone frame 4, a surround 51 and a diaphragm 52. A cone frame 4 has a container portion 41 disposed in an inner side of an opening of the cone frame 4. The container portion is recessed to form an L-shaped circular space. In addition, the container portion 41 comprises a retaining portion 411. A surround 51 has one end bonded to a circumference of a diaphragm 52 and another end fixed to the retaining portion 411 of the cone frame 4. The diaphragm 52, wherein the circumference of the diaphragm 52 is bonded to the surround 51 and sealed to the edge of the opening of the cone frame 4;

When an audio-frequency electrical signal is coupled with the voice coil inside the cone frame 4, the voice coil moves and then drives the diaphragm 52 to move and generate sounds. In the present invention, when the voice coil moves, the surround 51 helps the diaphragm 52 move more smoothly with less resistance and reduces a sound distortion while compared with the traditional structure.

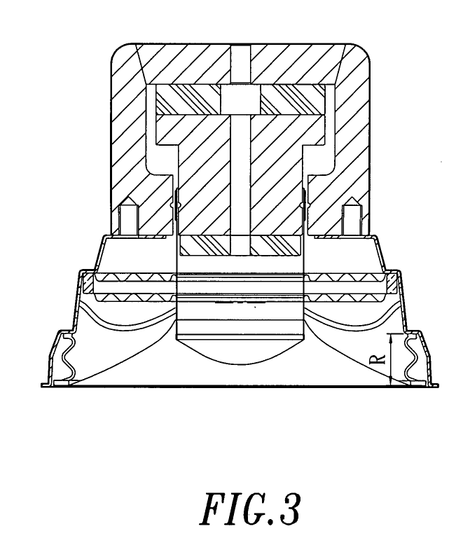

Please refer to FIG. 3 for a sectional view of an embodiment of the improved structure of the speaker in the present invention. The present invention uses an electrified conductor as the voice coil. As a result, when an audio-frequency electrical signal is coupled with the voice coil, the voice coil is acted like a current-carrying conductor. When the current-carrying conductor is placed in a fixed magnetic filed, according to Fleming's left hand rule, the voice coil is subject to a force proportional to the amount of current with its direction changed with the current; therefore, the voice coil would move in the magnetic field and drive the diaphragm to move, which in turn moves the air around the diaphragm, thereby converting electrical signals into radiating sound waves.

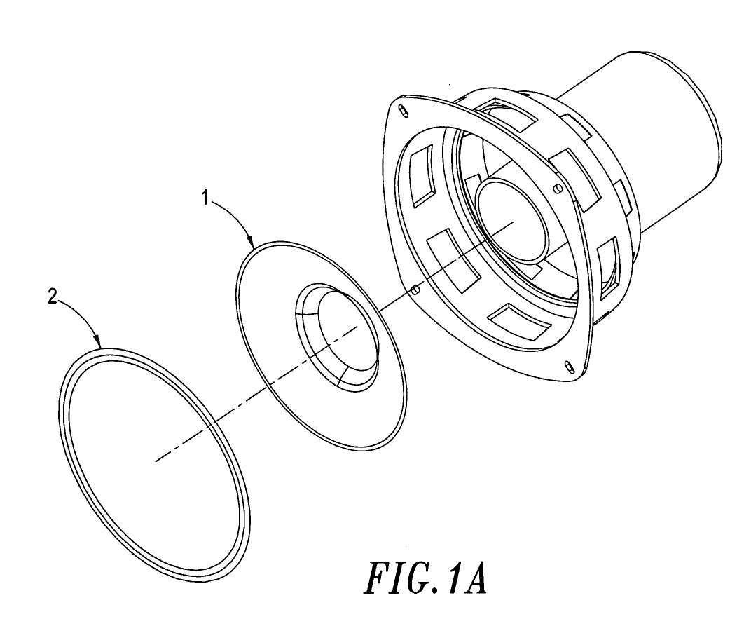

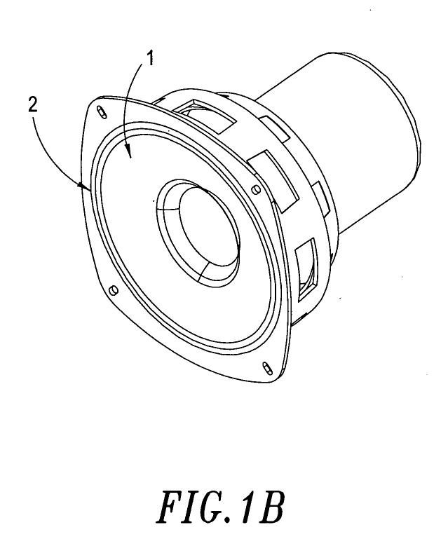

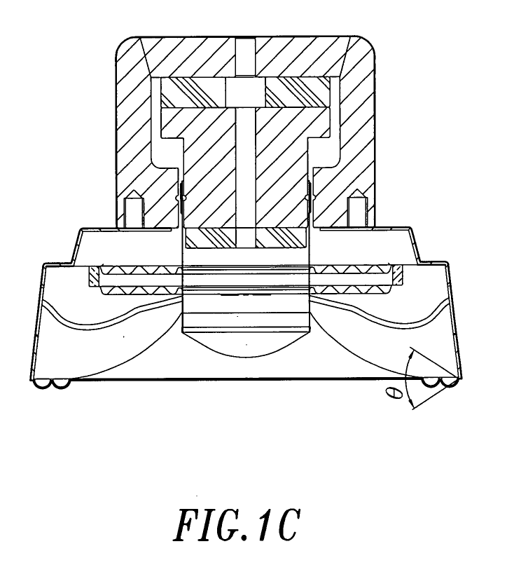

From FIG. 3, when the voice coil moves, the surround drives the diaphragm to move up and down with an effective height R. In comparison, the traditional speaker has its surround disposed on the plane of the diaphragm, when the voice coil moves, the surround drives the diaphragm to move up and down within a angle θ as shown on FIG. 1C, which limits the movement of the diaphragm and generates resistance to the movement of the diaphragm as well, then a sound distortion is generated.

In addition to the advantage described above, the present invention further limits the size of the cone frame to achieve the maximum effective moving area (Sd) to provide the best sound pressure efficiency, which is calculated as below:

$${V}_{as} = \frac{355 \times {( \frac{{s}_{d}}{π} )}^{2}}{{F}_{s}^{2} \times {M}_{m s}}$$

$${C}_{m s} = \frac{1}{{( 2 π \times {F}_{s} )}^{2} \times {M}_{m s}}$$

$${Q}_{es} = \frac{2 π \times {F}_{s} \times {M}_{m s} \times {R}_{e}}{{( BL )}^{2}}$$

$$\begin{matrix}{η}_{0} = \frac{9.64 \times {10}^{- 10} \times {F}_{s}^{3} \times {V}_{as}}{{Q}_{es}} \\ = \frac{9.64 \times {10}^{- 10} \times {F}_{s}^{3} \times \frac{355 \times {( \frac{{s}_{d}}{π} )}^{2}}{{F}_{s}^{2} \times {M}_{m s}}}{{Q}_{es}} \\ = \frac{9.64 \times {10}^{- 10} \times 355 \times {F}_{s} \times {( \frac{{s}_{d}}{π} )}^{2}}{{Q}_{es} \times {M}_{m s}} \\ = \frac{9.64 \times {10}^{- 10} \times 355 \times {F}_{s} \times {( \frac{{s}_{d}}{π} )}^{2} \times {( BL )}^{2}}{2 π \times {F}_{s} \times {M}_{m s}^{2} \times {R}_{e}} \\ = 5.51856 \times {10}^{- 9} \times ( \frac{{s}_{d}^{2} \times {( BL )}^{2}}{{M}_{m s}^{2} \times {R}_{e}} ) \\ = \frac{5.51856 \times {10}^{- 9}}{{R}_{e}} \times {( \frac{{S}_{d} \times BL}{{M}_{m s}} )}^{2}\end{matrix}$$

Vas is an equivalent air volume of the speaker. Sd is an effective moving area. Cms is a compliance of the suspension system. Qes is an electric damping factor. η₀ is an efficiency of the speaker unit. Re is a DC resistance of the voice coil. BL is a force factor contributed by the magnetic circuit and the wire lengths of the voice coil. Mms is a moving mass of the speaker including the air load. Msurround is a surround mass of the surround. Mvc is a voice coil mass. Mbond is a bond mass for the moving part, and Fs is a resonance of the speaker unit. Besides, the Mms for the traditional speaker is calculated as:

$${M}_{m s} = {M}_{cone + cap} + \frac{{M}_{surround}}{2 \sim 3} + {M}_{Vc} + {M}_{Bond}$$

In the present invention, the moving mass of the speaker (Mms) including the air load is calculated as:

Mₘₛ=M_{cone+cap}+M_{vc}+M_{Bond}

Therefore, the present invention can ignore the surround mass of the surround (Msurround) and achieve the maximum sound pressure efficiency of the speaker unit with the same size of that of the traditional speaker.

The present invention provides an improved structure of a speaker, while comparing with other prior art techniques, is advantageous in:
1. In the improved structure of the speaker, the placement of the surround makes the upward and downward movements of the diaphragm more smoothly with less resistance compared with the traditional structure and reduces the sound distortion.
2. The improved structure of the speaker in the present invention can ignore the surround mass of the surround (Msurround) and achieve the maximum sound pressure efficiency of the speaker unit with the same size of that of the traditional speaker.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An improved structure of a speaker, comprising:
a speaker unit at least comprising a diaphragm, a cone frame and a surround;
wherein the speaker unit is characterized in that the surround is disposed between the diaphragm and the cone frame, a circumference of the diaphragm is sealed to an edge of an opening of the cone frame, a container portion is disposed on an inner side of the edge of the opening of the cone frame, and the surround is disposed in the container portion.

2. The improved structure of a speaker as claimed in claim 1, wherein the container portion of the cone frame is recessed in the inner side of the opening to form an L-shaped circular space.

3. The improved structure of a speaker as claimed in claim 1, wherein the surround is fixed between the circumference of the diaphragm and the retaining portion of the cone frame.

4. The improved structure of a speaker as claimed in claim 3, wherein surround is fixedly bonded between the diaphragm and the cone frame.
